(19) United States
(12) Patent Application Publication
(10) Pub. No.: US 2016/0047880 A1
(43) Pub. Date: Feb. 18, 2016

(54) SYSTEM AND METHOD FOR LOCATION OF AIRCRAFT

(71) Applicant: Embry-Riddle Aeronautical University, Inc., Daytona, FL (US)

(72) Inventor: Albert D. Helfrick, DeLand, FL (US)

(21) Appl. No.: 14/816,160

(22) Filed: Aug. 3, 2015

Related U.S. Application Data
(60) Provisional application No. 62/037,279, filed on Aug. 14, 2014.

(51) Int. Cl. G01S 5/02; B64D 45/00

(52) U.S. Cl. CPC G01S 5/0231; B64D 45/00; B64D 2045/0065

(57) ABSTRACT

A system and method are provided that includes an aircraft secondary radar transponder activity detector that monitors an aircraft's transponder transmissions and activates an emergency locator transmitter to begin transmitting should the aircraft transponder transmissions cease to help locate an aircraft that may have become undetectable by conventional aircraft surveillance and tracking systems.

### CROSS REFERENCE TO RELATED APPLICATIONS

The present Patent Application is a formalization of previously filed, co-pending U.S. Provisional Patent Application Ser. No. 62/037,279, filed Aug. 14, 2014 by the inventors named in the present Application. This Patent Application claims the benefit of the filing date of this cited Provisional Patent Application according to the statutes and rules governing provisional patent applications, particularly 35 U.S.C. §119(e), and 37 C.F.R. §§1.78(a)(3) and 1.78(a)(4). The specification and drawings of the Provisional Patent Application referenced above are specifically incorporated herein by reference as if set forth in their entirety.

### FIELD OF THE DISCLOSURE

The present disclosure generally relates to systems and methods for monitoring, locating and tracking aircraft, and in particular to a system and method of detecting and locating aircraft that have become lost or otherwise out of range of detection by routine aircraft surveillance and/or tracking systems, or have failures of on board equipment that would provide locating information under normal circumstances.

### BACKGROUND

One typical method of insuring that aircraft are safely separated during flight is for a pilot to file a flight plan with the appropriate aviation authority, which is accepted as-is or modified. The aircraft filing the flight plan then flies a route according to the approved plan while various surveillance systems monitor the aircraft in addition to monitoring all other aircraft flying similar routes. Should the aircraft deviate from its approved flight plan, air traffic control will contact the aircraft, by voice or data radio, to inquire as to the intentions of the aircraft, and if the aircraft has strayed because of inattention or incorrect settings of a flight control system, the aircraft will be requested to either modify its flight plan or return to the approved plan.

Surveillance of aircraft in flight typically is maintained by primary and secondary radar systems. Primary radar systems provide an indication of an aircraft being present in a certain volume of the covered airspace, but do not provide identification of the aircraft or the altitude of the aircraft. Secondary radar systems communicate with the aircraft detected by a primary radar system and obtain information from the aircraft. This communication is accomplished automatically by digital data and requires little or no action by the crew during flight. Since the early days of using radar for air traffic control, altitude and identity of an aircraft generally have been obtained via the secondary radar system. Early secondary radar systems generally included the Air Traffic Control Radar Beacon System or ATCRBS, which communicates with a transponder installed on the aircraft. In almost all air space in the contiguous United States, the FAA requires the use of a transponder by all aircraft. The ATCRBS system required the air traffic control stations to assign a temporary identity called a “squawk,” which would be entered into the aircraft transponder using knobs or keyboard by the flight crew. There have been several general squawks used for visual flight indicators, such as for situations where there was no contact with air traffic control and for emergency situations such as failed radio communications, general emergency and hijacking. The use of these emergency squawks/codes would trigger alarms at air traffic control stations that an aircraft is in some form of distress and therefore is the first piece of equipment to be disabled by a hijacker or saboteur.

In the 1970's, as air travel increased, a need arose for more information to be obtained from aircraft, leading to improvements to the secondary radar system. In particular, an advanced secondary radar system called Mode-S, the “S” standing for “select,” was developed to replace the older ATCRBS system. The main advantage of the Mode-S system was the ability to selectively interrogate an aircraft to request data therefrom. The Mode-S system has the capability of assigning every aircraft throughout the world a unique identity, which is its International Civil Aviation Organization, ICAO, aircraft address. These addresses are assigned by the country of registration of the aircraft and therefore are known to the civil aviation authority of that country. Once the transponder is programmed with the unique aircraft address it cannot be modified from the flight deck. The Mode-S transponder, in addition to supplying information when requested, also spontaneously broadcasts information, which includes the aircraft's ICAO address. This broadcast is called “squitter” and is required for the Traffic and Collision Avoidance System, TCAS. The TCAS is required for larger aircraft by all civil aviation authorities throughout the world. The Mode-S squitter is an important enabler for the TCAS and generally cannot be disabled by means other than shutting down the transponder. An airborne aircraft that is not “squittering” may be invisible to TCAS and thus represents a potential threat.

Like the ATCRBS, the Mode-S transponders work with ground-based radar. For aircraft that are off-shore by more than about 200 nautical miles, however there is no radar coverage, as the propagation of the radar beam is essentially to the horizon. Therefore, the range of ground-based radar is dependent on the altitude of the aircraft, such that for aircraft flying at low altitudes, such as 5000 feet or less, the range could be a short as 40 nautical miles. This is the genesis of the term “flying under the radar.”

A newer type of aircraft surveillance system called Automatic Dependent Surveillance Broadcast ADS-B, currently is being installed worldwide. ADS-B broadcasts a considerable amount of data including the aircraft's ICAO address to improve situational awareness of nearby aircraft. ADS-B includes a ground infrastructure of ADS-B receiving and transmitting stations. ADS-B can also be received directly from nearby aircraft or relayed through a ground station. However, the range of the ADS-B broadcast of the identity and position of aircraft is, like ground-based radar systems, generally limited to a line-of-sight or to the horizon. Thus, for aircraft flying transoceanic or other flights more than 200 nautical miles from a ground station, no ground station will receive the ADS-B broadcast. If the air traffic is sparse, it is also possible that there may be no nearby aircraft to receive the broadcast.

As a result, for an aircraft that is more than 200 nautical miles offshore, or at a low altitude with no nearby aircraft, ATCRBS, Mode-S and ADS-B transmissions may not be received by any entity, such that the aircraft is, essentially invisible. ATCRBS, Mode-S and ADS-B although capable of transmitting emergency-related messages, are not reserved for emergency situations only. All aircraft flying under normal conditions will be making routine transmissions. Monitoring these transmissions from satellites or other spacecraft as a solution to the limited range problem for oceanic and remote flights, would result in huge interference due to the thousands of aircraft flying under normal conditions in view of the spacecraft.

Some newer aircraft also can have other communications systems, such as an Aircraft Communications, Addressing and Reporting System, ACARS, which provides Aeronautical Operational Control, AOC, and Aeronautical Administrative Control, AAC, communications. These services primarily are provided by a third party communications service provider or CSP, such as Aeronautical Radio Inc., and a few similar companies. AOC and AAC generally are for “private” company communications such as crew scheduling, dispatching, etc. They normally are not used for air traffic control, though some safety-related data may be exchanged, such as engine parameters and flight plan information. ACARS is not mandated by law and is not found on all aircraft.

Another system, generally reserved for emergency conditions, is called the Search and Rescue Satellite Aided Tracking, SARSAT, system, and consists of emergency locator transmitters, ELT, aboard aircraft and other vehicles such as ships and a worldwide network of monitoring systems, including satellites. SARSAT is an international consortium and is continually monitoring for ELT transmissions. SARSAT does not use dedicated satellites but relies on the installation of ELT receivers on other satellites. For example, different types of satellites such as communications, picture-taking, GPS, etc., have SARSAT receivers and can alert the SARSAT network if an ELT is detected. The ELTs on an aircraft generally are triggered by an impact switch which enables the transmitter when an aircraft comes into hard contact with the ground or water. Every ELT transmits its aircraft's identity, for example, the current 406 MHz ELT, which is required on all larger aircraft, transmits the aircraft's unique ICAO identity. The SARSAT network has a database showing the owner and contact information and other data. The SARSAT-monitoring satellites also represent different orbits such as geostationary, GEO, medium and low earth orbiting, MEO and LEO. Since GEO satellites have no coverage above 70 degrees of north latitude or south of −70 degrees of latitude, the MEO and LEO satellite orbits fill in this gap.

Accordingly, it can be seen that a need exists for a system and method of locating and tracking aircraft that have become lost or otherwise no longer detected by routine aircraft tracking systems that address the foregoing and other related and unrelated problems in the art.

### SUMMARY

The present disclosure includes a system of locating an aircraft in an emergency condition. To operate, the system may include an emergency locator transmitter (ELT) located on board the aircraft, and an ELT detection/locating system including an interface unit in communication with the ELT, the interface unit includes an activity detector configured to monitor an aircraft transponder and potentially any other equipment that transmits radio signals required for locating and tracking of the aircraft. Other signals may include transmissions made by the onboard transponder and TCAS systems as well as any current or future systems involved in aircraft surveillance. The ELT is directed to transmit a signal configured to be detected by satellite-based receivers when the transponder activity detector fails to detect an expected transmission signal from the aircraft transponder while the aircraft is in operation.

The present disclosure also includes a method of initiating an emergency transmission from an aircraft for use in locating or detecting a position of the aircraft. Steps of the method may include monitoring expected transmissions from a Mode-S transponder aboard the aircraft using a transponder activity detector located on the aircraft while the aircraft is in flight. Steps may also include initiating an active alarm state when the transponder activity detector fails to receive the expected transmission. The method may also include triggering an emergency locator transmitter (ELT) to transmit a signal indicative of an emergency condition from the ELT. The system may perform its intended function with no interaction with the crew. In one embodiment, the system cannot be controlled in any way from the flight deck but can be “reset” on the ground. The operation of the system may be completely invisible to the flight deck while in flight.

### BRIEF DESCRIPTION OF DRAWINGS

FIG. 1 is a block diagram illustrating one example embodiment of an aircraft detecting and locating system according to some principles of the present disclosure.

Those skilled in the art will appreciate and understand that, according to common practice, the various features of the drawings discussed below are not necessarily drawn to scale, and that the dimensions of various features and elements of the drawings may be expanded or reduced to more clearly illustrate the embodiments of the present invention described herein. Additionally, various objects, features and advantages of the present invention will become apparent to those skilled in the art upon a review of the following detailed description when taken in conjunction with the accompanying drawings.

### DESCRIPTION OF THE INVENTION

The present invention is directed to a system and method for the detection and/or location of an aircraft that has lost contact with air traffic control or other surveillance systems such as when the aircraft is out of radar range or its Mode-S transponder ceases transmission. In one embodiment, the aircraft detection/locating system 1 of the present disclosure can be integrated with or can be operable to enable an emergency locating device such as an emergency locator transmitter (ELT) 2. If the systems used for routine aircraft location and tracking, that rely on radio transmission such as Mode-S transmissions known as squitter, cease while in flight or otherwise be blocked or not be transmitted, the aircraft detection/locating system 1 can automatically, and substantially without human interference, enable, trigger and/or activate the aircraft's ELT 2.

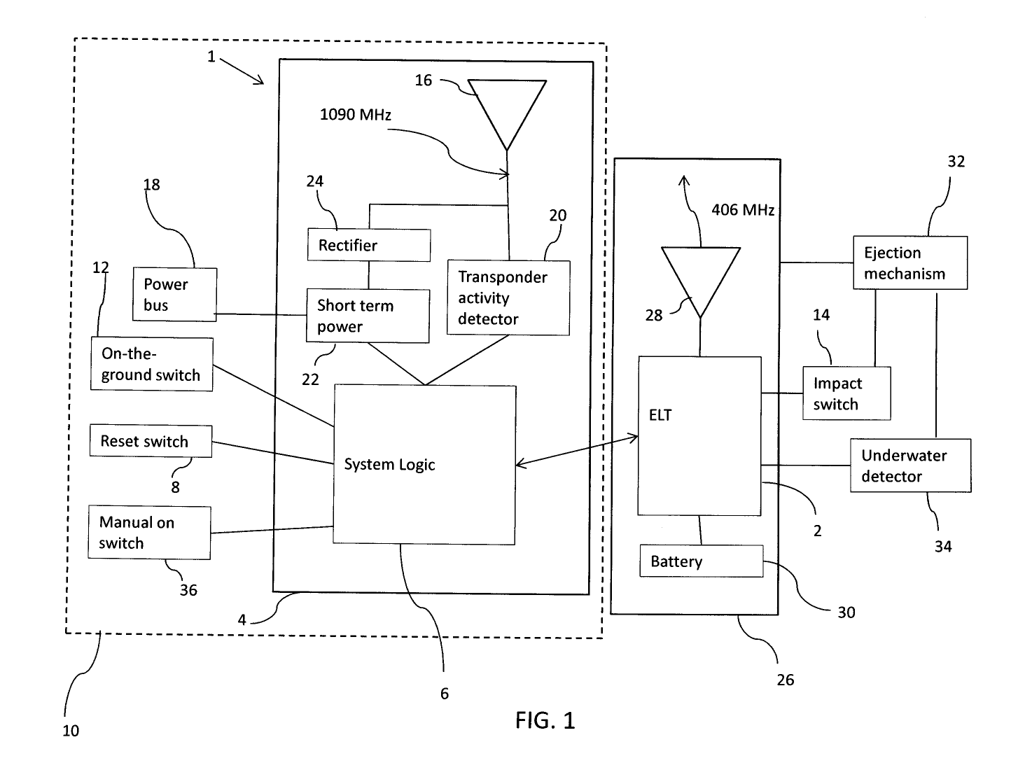

FIG. 1 illustrates one example embodiment, in which the detection/locating system 1 that can be located within an aircraft or other vehicle and generally can include an interface unit or module 4. The interface unit 4 may generally include a controller, e.g., system logic 6, which can include a programmable chip or control module, and which may communicate with both the aircraft navigation and operational control systems, and the aircraft's Mode-S transmitter system. The interface unit 4 further communicates with the emergency locator transmitter (ELT) 2. The ELT is shown in FIG. 1 as a 406 MHz ELT such as used by virtually all civil aircraft. In one embodiment, the interface unit 4 can be integrated into or otherwise part of the ELT 2 of the aircraft, in which case the detection/locating system 1 and ELT may be configured as a single module. Alternatively, the interface unit 4 could be provided as a separate module that is electrically and physically autonomous. This implies the interface unit 4 is physically inaccessible during flight and that any electrical connections that could affect the operation of the interface unit 4 or the ELT 2 are, likewise, inaccessible during flight.

The interface module or unit 4 can receive or supply a series of commands and/or status signals as part of its communications with the ELT 2, for example, receiving a signal from the ELT that it is transmitting, and in turn, signaling a change of mode or state to the ELT 2, such as manual on (transmit), armed (to be triggered by an ELT impact switch), and reset (reset after a false alarm or a downed aircraft has been located). The normal signals to and from the ELT 2 should not be affected by the addition of the interface unit 4, with the exception of a possible “reset” function. This “reset” function, as provided by a reset switch 8 provided aboard the aircraft 10, is for the purpose of resetting a triggered ELT after a downed aircraft has been located or after a severe gust falsely triggered the ELT 2. During flight the reset function may be inhibited. An “on the ground” signal, provided by an on-the-ground switch 12, which is on most aircraft, because it is required for various systems, provides a signal to determine the aircraft is airborne. Because the normal ELT “reset” function may be initiated from the flight deck this function should be inhibited during flight to prevent potential saboteurs from defeating the detection/locating system by continually resetting the ELT 2. If the ELT 2 is enabled by extreme turbulence, the ELT can be reset when the aircraft is on the ground. The resetting may be performed from the flight deck or from a location that would not be accessible while the aircraft is in flight. An alternate modification of the reset function would allow resetting from the flight deck only if the trigger came from an impact switch 14, and not from the interface unit 4. The interface unit 4 also can initiate or run a sampling loop using the Mode-S transponder or a separate antenna/receiver 16; and can monitor/measure the radio frequency energy from the Mode-S transponder transmitter to see if it indicates proper transmission from the Mode-S transponder. In addition, the interface unit 4 can receive information from the aircraft 10; such as a signal that a weight-on-wheels or “on-the-ground” switch 12 is active; indicating the plane is on the ground. The interface unit 4 thus can monitor aircraft conditions and automatically activate the ELT 2 if it determines a fault or emergency condition exists.

As further indicated in FIG. 1, in one embodiment, the interface unit 4 or module can be linked to and can draw power from aircraft systems within the aircraft 10, such as via a power bus connection 18 linking the interface unit 4 to a power supply of the aircraft or to a battery or other on-board power source, and further will include a transponder activity detector 20 that monitors the aircraft transponder, such as the S-mode transponder. Additionally a short term power source 22, such as a battery or other energy storage device, is located in the interface unit 4 to provide back-up power for a period of several hours or more. This may ensure that if the aircraft power to the interface unit 4 is lost due to a total loss of aircraft power or by a deliberate action, that like the ELT 2, the interface unit 4 is operating on battery power and the function of the interface unit 4 and ELT 2 is not disrupted. In addition, the energy received by the receiver 16 from the onboard transmitters can be “harvested” by using a rectifier 24 capable of converting a signal from radio frequency to direct current. The rectified signal or signals may be used to provide an energy source to charge a battery or other energy storage device such as the short term power source 22. The transponder activity detector 20 of the detection/locating system 1 of the present disclosure may include an L band receiver 16 for detecting and receiving Mode-S/ADS-B transmissions (squitter transmissions) and communicating those transmissions and/or the lack thereof to the ELT 2, and can activate the ELT 2 upon detection of an emergency condition such as the Mode-S transponder ceasing to transmit expected squitter transmissions or being shut off. In some embodiments, the transponder activity detector 20 can be placed within an ELT module or pod 26 along with the rest of the interface unit 4 to provide isolation of the transponder activity detector 20, from the aircraft and/or aircraft control systems and thus substantially prevent or minimize disabling of the detector and/or the ELT during flight. The electronics for the transponder activity detector 20 also should be designed or configured to operate using minimal power/energy consumption. The Mode-S transmitter squitter also generally would be transmitted from top and bottom mounted antennas. Thus, an ELT 2, communicating with an interface unit 4 according to the present disclosure, should receive a strong signal that could possibly be used for “energy harvesting.”

In one embodiment, the ELT 2 will be of a position indicating type, i.e., an EPIRB, which can transmit the current position of an aircraft derived from an on-board GPS receiver. The ELT 2 further can include an antenna 28, its own energy source in the form of a long-life battery 30, and can be contained in the separate pod 26 that can serve as a protective casing or ejection pod to protect the ELT 2 upon a crash, and to isolate the ELT 2 and the detector 20 of the detection/locating system 1 from the aircraft systems. The pod 26 can be mounted within the aircraft at a location such that if the aircraft equipped with this invention crashes, or makes a water landing or a water crash, the subject ELT 2 can be ejected from the fuselage of the aircraft, and can be configured such that it will float.

The ELT 2 of the present disclosure may be further operable with or as part of a water activated ejection mechanism 32. As indicated in FIG. 1, the ELT 2 can be housed in a casing or pod 26 that can be formed from a highly impact resistant and buoyant material. The ELT ejection further can be triggered by either the impact switch 14 or an underwater detector 34. The underwater detector 34 also will generally be configured, or of a type, that rain or condensation does not trigger the ejection mechanism, rather, the aircraft must be submerged for the ejection to occur.

The ELT 2, upon separation from the aircraft, transmits on an internationally-specified emergency frequency, for example on 406 MHz, and if equipped with a GPS receiver can substantially continuously transmit the position of the ELT 2. The ELT 2 can transmit the unique ICAO 24 bit aircraft identification. The free-floating ELT 2 may be carried by ocean currents and winds. However, the ELT 2 will begin transmitting at a point of contact with the water which can provide an approximate position needed for locating aircraft wreckage. The ELT 2 will generally continue to report its position for as long as the battery 30 has sufficient charge. This information can indicate the path of any floating debris from the crash and can aid in locating the debris field. If the aircraft crashes on land, the ELT 2 can perform the same ejection function and reporting of its position.

In addition, one of the advantages of the ELT 2 of the present detection/locating system 1 is that the ELT 2 can be isolated so as to not be accessible from inside the aircraft. The ELT 2 is located within the aircraft fuselage such that its antenna 28 has a clear shot to space for its transmission signals to be received by monitoring spacecraft, e.g., satellites, or other terrestrial-based receivers, but the ELT 2 is located in a location so as to be inaccessible from within the aircraft during flight, especially in larger aircraft. Still further, the ELT 2 generally contains its own energy source, such as the battery 30, and there is no circuit breaker that could be turned off to disable the ELT 2.

To preserve internal battery energy, the ELT 2 of the present system will be configured to draw very little or no current when not activated. For example, by rectifying the transponder signal received by the transponder activity detector 20 with a rectifier 24, energy can be harvested from this transmission for powering the ELT 2, either directly or through the interface unit 4, while in an inactive state. In some embodiments, such as where the detection/locating system 1 is integrated within the ELT 2, the transponder activity detector 20 further can be powered from the ELT battery 30, without a separate short term power source 22, though this generally will add an additional load on the battery 30, thus reducing its life. Eliminating the additional load on the ELT battery 30 can be achieved by providing primary power to the transponder activity detector 20 from the aircraft itself, such as via a bus connection 18 as indicated in FIG. 1, or other primary power source, with the ELT battery 30 being operable as a back-up power source as needed. As a further alternative, as noted, by rectifying the strong Mode-S transponder signal received by the receiver 16, energy harvested therefrom further could be used to power the transponder activity detector 20, so as to avoid a drain on the ELT battery 30.

In addition, by linking the detection/locating system 1 to and providing power therefor from a “critical” or “essential” power source (i.e., a power bus connection 18 to the aircraft power system), the loss of this source of power may be configured to indicate an emergency condition, or at least trigger a warning within the flight deck. For example, the transponder activity detector 20 can be designed such that a loss of such an essential or critical primary power source for the aircraft 10 causes the transponder activity detector 20 to activate the ELT 2 to transmit using ELT's battery 30. Once the ELT 2 is ejected and activated, the loss of power, and the loss of the transponder activity detector 20 may no longer be needed, and may not affect the maximum time the ELT 2 can transmit.

Features may be provided in association with the interface unit 4 or the aircraft 10 to prevent false alarms, when there are legitimate circumstances where the aircraft transponder may not be active. For example, if the aircraft power is completely turned off, such as when the aircraft is parked and not in use, the transponder should not be active. To prevent the ELT 2 from transmitting when the aircraft is totally powered down, including the essential or critical power, an on-the-ground switch 12 can be used to inhibit the ELT 2 from transmitting. Such on-the-ground switches 12 are available on all large aircraft because they are used with several existing systems.

When the aircraft is powered up, its transponder should be active, even if not being interrogated, transmitting “squitters” or spontaneous transmissions. These squitters are generally required for the collision avoidance system, TCAS, and for Automatic Dependent Surveillance Broadcast, ADS-B, a system that will be required in nearly all aircraft by 2020. These squitters are active whether the aircraft is airborne or on the ground. Once active, if the receiver 16 of the transponder activity detector 20 detects a lack of activity from the 1090 MHz transmissions from the Mode-S transponder aboard the aircraft, either a lack or ceasing of transmission of squitters or replies, the ELT 2 will be triggered and caused to transmit an emergency signal. In some cases, an aircraft on the ground may not be squittering for legitimate reasons. In this case, false alarms may be prevented by the use of the on-the-ground switch 12. There is a weight on wheels signal on all larger aircraft to prevent false alarms from other systems such as TCAS that can be used for this logic.

In another example, the interface unit 4 can include logic whereby, if the aircraft is airborne, and the on-the-ground switch indication is false, i.e., it is active, and indicating weight on the aircraft wheels, and the Mode-S transponder is not transmitting, the ELT 2 is triggered. Also, a reset switch 8 and visual alert that are generally available in the cockpit for controlling the ELT 2 can be inhibited. This means that the activation of ELT transmissions may not be annunciated in the cockpit, and cannot be reset for this set of conditions. However, if the aircraft is on the ground, and thus on-the-ground switch indication is true, and the transponder is not transmitting, the ELT 2 will not be activated unless an impact switch 14, triggers the ELT 2. The impact switch 14 can always trigger the ELT. This ensures the ELT 2 will be triggered for any impact, airborne or on the ground. In addition, a manual-on switch 36 provided in the cockpit can trigger the ELT 2. The manual-on switch 36 operates under normal conditions, such as when the aircraft is airborne or on the ground. Additionally, the disclosed detection/locating system 1 may be configured that if the ELT 2 is triggered while airborne because of a loss of the Mode-S transponder transmission, the ELT can be reset in the normal manner only after the aircraft has landed. This ensures that if the Mode-S transponder was inadvertently disabled by crew error, the ELT will only transmit for the remainder of the flight.

Emergency Locator Transmitters are certified and intended to be for emergency situations only. It is believed, however, that an aircraft that is no longer transmitting normal signals used for surveillance, such as ADS-B or squittering, while in flight is in an emergency situation and thus, a transmitting ELT 2 would not violate international agreements on the use of the ELT. The Mode-S transponder is such a critical piece of equipment that most larger aircraft have two installed. An aircraft without a functioning Mode-S transponder will either be denied permission to take off, or if already in flight, directed to a nearby airport for repairs. This ensures a low probability of aircraft with nonfunctioning transponders triggering the ELT 2.

The ELT 2, usually transmitting on a frequency of 406 MHz, will be received by any one of literally dozens of satellites. The data is disseminated using the COSPAS/SARSAT search and rescue network and is available worldwide to government agencies. The 406 MHz ELT can transmit the identity of the aircraft using the ICAO 24 bit aircraft identity. The COSPAS/SARSAT system has demonstrated its worth quickly locating aircraft and saving lives for over 25 years.

Although the ELT is an aid to locating downed aircraft that have crashed or made an emergency landing not at an airport, the ELT also can be used to identify aircraft that cannot be located by the usual means of primary and secondary radar. Unidentified or missing aircraft can be as problematic as a crashed or downed aircraft. Aircraft that are no longer being identified are potential collision targets or may be hijacked with the intent on causing damage and/or death. Therefore, an unidentified aircraft can be considered as an emergency situation and thus warrants the use of the emergency locator transmitter. This should satisfy the COSPAS/SARSAT requirements that the ELT be for emergency situations.

The foregoing description generally illustrates and describes various embodiments of the present invention. It will, however, be understood by those skilled in the art that various changes and modifications can be made to the above-discussed construction of the present invention without departing from the spirit and scope of the invention as disclosed herein, and that it is intended that all matter contained in the above description or shown in the accompanying drawings shall be interpreted as being illustrative, and not to be taken in a limiting sense. Furthermore, the scope of the present disclosure shall be construed to cover various modifications, combinations, additions, alterations, etc., above and to the above-described embodiments, which shall be considered to be within the scope of the present invention. It therefore will be understood by those skilled in the art that while the present invention has been described above with reference to preferred embodiments, numerous variations, modifications, and additions can be made thereto without departing from the spirit and scope of the present invention as set forth in the following claims. Accordingly, various features and characteristics of the present invention as discussed herein may be selectively interchanged and applied to other illustrated and non-illustrated embodiments of the invention, and numerous variations, modifications, and additions further can be made thereto without departing from the spirit and scope of the present invention as set forth in the appended claims.

1. A system of locating an aircraft in an emergency condition, comprising:
an emergency locator transmitter (ELT) located on board the aircraft; and
an ELT detection/locating system including an interface unit in communication with the ELT, the interface unit includes a transponder activity detector configured to monitor an aircraft transponder transmission signal;
wherein the ELT is directed to transmit a signal configured to be detected by satellite-or terrestrial-based receivers when the transponder activity detector fails to detect an expected transmission signal from the aircraft transponder while the aircraft is in operation.

2. The system of claim 1, wherein the interface unit is powered by a power bus connection to the aircraft.

3. The system of claim 2, wherein the transponder activity detector triggers the ELT to transmit upon detection of cessation of current passing through the power bus, and the transponder activity detector begins receiving power from a short term power source.

4. The system of claim 1, further comprising a rectifier to harvest energy from at least the transmission signal.

5. The system of claim 1, wherein the interface unit of the detection/locating system determines an air/ground status of the aircraft from an on-the-ground switch of the aircraft to determine when a transmission from the transponder is expected.

6. The system of claim 1, wherein the ELT and the ELT detection/locating system are located within a pod.

7. The system of claim 6, further comprising an ejection mechanism configured to automatically separate the pod from the aircraft,
wherein the ELT transmits the signal when separated from the aircraft.

8. The system of claim 7, wherein the ejection mechanism comprises an impact detector to separate the ELT from the aircraft after an impact.

9. The system of claim 7, wherein the ejection mechanism comprises a submersion detector to separate the ELT from the aircraft when the ELT becomes submerged under water.

10. The system of claim 1, wherein the ELT has an antenna configured to transmit an emergency signal; and
the transponder activity detector has a receiver configured to receive the aircraft transponder transmission signal.

11. A method of initiating an emergency transmission from an aircraft for use in locating or detecting a position of the aircraft, comprising:
monitoring expected transmissions from a Mode-S transponder aboard the aircraft using a transponder activity detector located on the aircraft while the aircraft is in flight;
initiating an active alarm state when the transponder activity detector fails to receive the expected transmission; and
triggering an emergency locator transmitter (ELT) to transmit a signal indicative of an emergency condition from the ELT.

12. The method of claim 11, further comprising powering the transponder activity detector from a power bus of the aircraft.

13. The method of claim 12, further comprising triggering the ELT when current from the power bus ceases.

14. The method of claim 11, further comprising harvesting energy from the transmissions provided by the transponder of the aircraft using a rectifier; and
storing the harvested energy to extend the operating time of the transponder activity detector and/or the ELT when aircraft power is lost.

15. The method of claim 11, further comprising communicating with an on-the-ground switch of the aircraft and determining if a transmission from the transponder is expected by receipt of an active signal from the on-the-ground switch before triggering the ELT.

16. The method of claim 11, further comprising ejecting the ELT from the aircraft.

17. The method of claim 16, further comprising detecting an impact of the aircraft and ejecting the ELT in response to the impact.

18. The method of claim 16, further comprising detecting a submersion of the aircraft under water, and ejecting the ELT in response to the submersion.

19. The method of claim 11, wherein the signal includes position indication and is transmitted for receipt by the SARSAT network, and
wherein the expected transmission is a data signal sent from an S-mode transponder.

20. The method of claim 11, further comprising:
prohibiting resetting the ELT while the aircraft remains in flight.
